(19) United States
(12) Patent Application Publication
(10) Pub. No.: US 2007/0185723 A1
(43) Pub. Date: Aug. 9, 2007

(54) Method and apparatus for facilitating consumer and employment interview transactions

(76) Inventor: Richard Wells Shellnutt, Aiken, SC (US)

Correspondence Address: RICHARD SHELLNUTT, 6330 Ashton Park Place, Colorado Springs, CO, 80919, US

(21) Appl. No.: 11/346,440

(22) Filed: Feb. 3, 2006

(51) Int. Cl. G06Q 99/00

(52) U.S. Cl. 705/1

(57) ABSTRACT

The present inventive method and apparatus facilitates consumer transactions whereby a website system facilitates consumer product and service purchasing via a global communication network to a vendor or group of “employer” computers in response to the receipt of a job listing request from a consumer computer via the network. Thereafter the website system receives resumes and virtual interviews to record from a host of “job seekers” indicative of an interest to complete a transaction or obtain employment. The website system then sends to the “employer” computer email notification with an access link embedded for the “employer” to view a recorded virtual interview and copied resume. Additionally whence the “employer” views the “job seeker” virtual interview and resume, the “employer” may utilize the server system in the same manner to suggest and construct a follow-up interview with a “job seeker.” This process may continue in a cyclical manner until ended by either the consumer or said inventor.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Technical Field

The present invention relates in general to a method and apparatus for facilitating employment interviews and consumer transactions. It more particularly relates to such a method and apparatus for facilitating employment interviews and consumer transactions over global communications networks, such as the Internet, to facilitate the promotion of the sale of goods and services to a very large number of different types and kinds of consumers. Definition: The “virtual interview” referred to herein is defined as a recorded live interview that includes real time audio and video of a “real person” or “job seeker” and does not refer to said person being a virtual person or animated version of said person. Further, the “Virtual Assistant” named herein does relate to or can be defined as a recorded live interview that includes real time audio and video of a virtual person or animated version of a person. Said “real person” and said “Virtual Assistant” interact in said “virtual interview” using said real time audio and video which is recorded and able to be re-played for viewing at a later time over said global communications networks, such as the Internet.

2. Background Art

There have been many different consumer related services regarding the sale of products and services over global computer networks, such as the Internet. For example, reference may be made to the following U.S. patents: U.S. Pat. Nos. 5,832,497; 1,865,185; 2,270,756; 1,410,254; 1,997,526; 2,148,185; 2,224,722; 2,226,653; 1,476,678; 2,204,268; 2,182,079; 2,073,345; 1,910,588; and 1,931,291.

One familiar approach is to sell goods and services, whereby a prospective consumer or “job seeker” is permitted to view employment opportunities where large databases of job openings may be offered. For this purpose a website is utilized to enable a seller of products or services to post “job openings” and “products to assist in the search for job placement” to attract consumers or “job seekers.” Consumers or “employers” may then place their purchase orders over the Internet, whereby the goods and services may then be viewed by the consumer or “job seekers.” However, the disadvantage to the consumer or “job seeker” is that he or she is competing often times against many other prospective consumers or “job seekers”, and thus the chances of the consumer obtaining job placement may become harder to obtain by the amount of consumer or “job seekers” entering the same resource or network.

Another approach has been to allow consumers or “job seekers” to accumulate multiple entries within the same resource or network to increase the probable chance of obtaining job placement. The identification of a consumer or “job seeker” and their entry accumulation is then communicated to a web server, such as a database and they are entered into a large pool of prospective consumers or “job seekers” to be selected as a viable employment candidate by an employer. A web server or database enables consumers or “job seekers” to apply for employment opportunities filling out job applications in the convenience of the job seeker's home or wherever they have access to the Internet. The website owner enables consumer's or “employers” the convenience of viewing prospective employee applications without having the applicant physically present. In an effort to create consumer loyalty and to attract other prospective consumers, website owners enable consumers “job seekers” and “employers” the convenience of Internet job searching from the comfort of home or remote office locations.

Additionally others approach the sale of goods and service or “employment opportunities” over the Internet in a more traditional manner by listing a catalog of job opportunities and allowing applicant's to send resumes in response to employer posted job openings. In this traditional approach the vendor may boast that they are the most successful recruiter available which is designed to create customer satisfaction.

While such approaches are highly desirable and are proven commercially successful, there are common problems with each business model that limit consumers. Consumers that have been loyal to a particular employment network or website for a long period of time are yet to benefit from their loyalty other than the mediocre products or services they have purchased. Consumers “job seekers” and “employers” are often subject to higher costs and greater time expenditures to offset unemployment. Additionally, consumers or “job seekers” face immeasurable odds when placed in a huge pool of other prospective applicants in hopes to be selected as a prospective employee.

Therefore, it would be highly desirable to have a system and a method for use in global computerized networks, such as the Internet, whereby a website owner can offer “job seekers” a much higher probability of employment and “employers” a more cost effective means for interviewing prospective employees. Further, the “employer” can take advantage of time and cost savings, and the “job seeker” is enabled to interview for jobs without leaving home. Using the Internet, the inventor's specially programmed web server, and a web cam, the “job seeker” is able to personally demonstrate their experience and the “employer” is able to view the recorded interview using a computer and the Internet to log onto the inventor's specially programmed web server. This process empowers both consumers or “job seekers” and “employers” and greatly increases their chance of satisfying employment needs.

### SUMMARY OF THE INVENTION

Therefore, the principal object of the present invention is to provide a new and improved method and apparatus for facilitating an employment interview related service enabling consumer commerce transactions over a global communications network or other approaches.

Another object of the invention is to provide such a new and improved method and apparatus whereby a consumer “job seeker” can answer a list of interview questions provided by an “employer” in a virtual interview setting. Additionally, consumers or “job seekers” use a web cam and the inventor's web server system that records them while answering interview questions, which will be viewed by potential “employers.” These web server interviewing services may enhance the consumers or “job seekers” ability or aid the completion of filling employment opportunities. The use of web cams and proprietary web server programming and software will enable “job seekers” to interview for jobs in a traditional interviewing setting but at times and places that are preferable to the “job seeker.” Additionally, the “job seeker” will be able to interview for many different job opportunities without being personally invited to physically interview by “employers.” Therefore, “job seekers” decide which jobs to interview for using the inventor's web server system, and the “employer” no longer has to initiate an interview with the “job seeker.” Additionally the “employer”, at times that benefit their work schedule, can view the recorded interviews of “job seekers” selecting “job seekers” that answered the interview questions to the “employers” satisfaction.

Briefly, the above and further objects of the present invention are provided by utilizing a system server for a global communications network to enable a consumer or “job seeker” to have the ability to access a website and interview for a very larger number of job opportunities. Additionally, the consumer or “job seeker” may receive job offers by competently answering the “employers” interview questions that have been entered into the web server prior to the “job seekers” web cam interview. The web server automatically issues the “employer” interview questions to the “job seeker” when said “job seeker” initiates a virtual interview from said web server that is accessed over the Internet. Further, said “job seeker” views the face of a person or virtual person “interviewer” on their computer screen generated by said inventor's web server that asks the “job seeker” the “employers” interview questions. Additionally, the “job seeker's” answers to the “employer's” interview questions are recorded by said web server through the utilization of a “job seekers” web cam, personal computer and said web server, which is accessed over the Internet. The “job seekers” interview questions are saved for review by said “employers” using a personal computer while accessing said web server using the Internet.

The present inventive method and apparatus facilitates consumer transactions whereby a website system server communicates with the logged on consumer or “job seeker” and or “employer” instructing different stages and time frames that tasks must be completed in order for the consumer or “employer” to successfully post employment opportunities and consumers or “job seekers” to successfully interview for job opportunities using said web server. Further, the consumer or “job seekers” and “employers” are instructed over a global communications network to follow strict guidelines for use wherein the consumer must enter various identification data and personal qualifications and interview questions whence the web system server determines whether the consumer has completed the identification forms and questions successfully. The web system server communicates with the logged on consumer or “job seeker” using the inventor's website verifying whether the consumer has successfully been registered which enables the “job seeker” to initiate online interviews using said web server system and said website. The consumer or “job seeker” and “employer” is able to interact directly with the inventors website server over a global communications network for “job seekers” to interview for job opportunities and “employers” to view recorded said interviews. Furthermore, the inventor's system server directly communicates the “employers” interview questions to the “job seeker” once the job seeker is properly registered and initiates the “employers” interview questions via the inventor's website.

The website system charges a modest fee per item or service sold from the inventors website systems home page and web pages. Additionally, the inventive method and apparatus will serve as a promotional website commercially recognized for its ability to enable consumers or “job seekers” to interview for jobs over the Internet. The invention will enable “job seekers” to converse with a virtual human interviewer or “Virtual Assistant” and answer prearranged questions prescribed by “employers.” Additionally, “employers” will be able to watch the “job seeker” converse with the virtual interviewer or “Virtual Assistant” by accessing a recording on said web server system's website without having to personally perform the interview themselves. Third party vendors that wish to be affiliated with the website system must sign agreements to pay commissions to inventor for third party products sold off of said inventors website system.

### BRIEF DESCRIPTION OF ILLUSTRATED DRAWINGS

The above mentioned and other objects and features of this invention and the manner of attaining them will become apparent, and the invention itself will be best understood by reference to the following description of the embodiment of the invention in conjunction with the accompanying drawings, wherein:

FIG. 1 is a functional block diagram illustrating the method and apparatus according to the present invention;

FIGS. 2 and 3 are flow charts illustrating the method of the present invention; and

FIGS. 4 through 20 are illustrations of various website display screens and information input screens for the method and apparatus of FIG. 1;

### BEST MODE FOR CARRYING OUT THE INVENTION

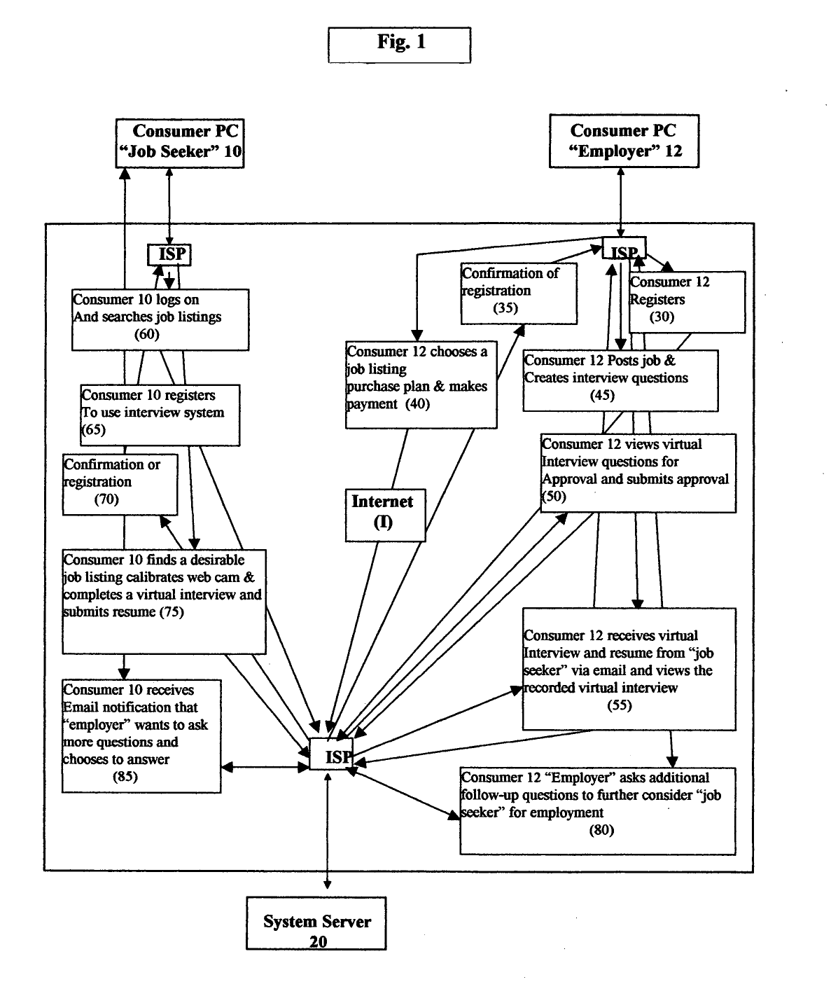

Referring now to the drawings, and more particularly to FIG. 1 thereof, there is shown a system 20, which is constructed in accordance with the present invention, and which enables a consumer “employer” to log on to the inventor's web server using the Internet (I). The consumer 12 “employer” registers to use the inventor's web server system by filling out a form on web server 20 providing consumer 12 “employers” identification information required by the inventor's web server system 20 as indicated at 30. Once consumer 12 “employer” has completed said identification form or registration form, said “employer” receives a confirmation of registration from the inventor's web sever system 20 as indicated at 35. Consumer 12 “employer” then chooses which employment purchase plan to use to post a job opportunity on the inventor's web server system 20. Said “employer” then proceeds to a payment form on said web server system 20 and fills out payment information as indicated at 40. Payment is processed using said web server system 20. Once payment has been processed, consumer 12 “employer” is asked to fill out a separate form on the inventor's web server system 20 that enables them to post a title and description of the job opportunity they have available and what requirements “if any” are expected for potential “job seekers” to possess as indicated at 45. After said “employer” has created a description of said job opportunity by completing a form on said web server system 20, the “employer” is asked to fill out a form on the inventor's web server system 20 that enables the “employer” to create and list interview questions for “job seekers” to answer as indicated at 45. Each interview question will be stored on the inventor's web server system 20.

Once the consumer 12 “employer” composes and completes all of the interview questions desired, said “employer” is able to view a virtual human face or “Virtual Assistant” play back said “employers” interview questions using said inventor's website for approval as indicated at 50. Said “Virtual Assistant” is generated, animated and moves, sounds and speaks as a living human being however, it is a computer generated image programmed and devised by inventor's web server system 20 and displayed on said “employers” personal computer screen via said inventor's website using the Internet (I). If consumer 12 “employer” is satisfied with said play-back, said “employer” submits their approval as indicated at 50. The job listing and interview questions as indicated at 45 are stored on system server 20 and accessible to any consumer 10 “job seekers” via the Internet (I).

A consumer 10 “job seeker” is able to log onto system server 20 via the Internet (I) using their own Internet Service Provider (ISP) and able to navigate to all job listings available on system server 20 without registering as indicated at 60. Once a consumer 10 “job seeker” views a job listing that is desirable they must register or fill out a personal identification form to be eligible to send a resume or answer the consumer 12 “employers” interview questions as indicated at 65. Once the consumer 10 or “job seeker” completes said registration, they will receive a confirmation notification from system server 20 that enables them to submit resumes and answer consumer 12 “employers” interview questions as indicated at 70. A consumer 10 “job seeker” will be able to navigate to a specific job listing by using a search engine on system server 20 from web pages generated by system server 20. As consumer 10 “job seeker” selects a specific job listing to submit a resume and answer consumer 12 “employers” interview questions via a virtual interview setting, they will be prompted by system server 20 to fill out their identification information and to plug in their web cam for system server 20 calibration as seen at 75. The consumer 10 “job seeker” will be able to view and interact with said “Virtual Assistant” during calibration. System server 20 generates a trial conversation or interview with consumer 10 “job seeker” that enables said “job seeker” to understand the interaction process before starting the real virtual interview whence answering consumer 12 “employers” questions may not be repeated or re-used, viewed or re-played once consumer 10 “job seeker” selects an option during said calibration process starting the real virtual interview process. Said consumer 10 will be able to start said real virtual interview process by depressing a link on the system server 20 website web page stating “Start Interview.”

A consumer 10 “job seeker” starts the interview process by depressing said “Start Interview” link on system server 20 web site. Said consumer answers all of consumer 12 “employers” interview questions via the virtual interview web program conversing with the “Virtual Assistant” generated by system server 20 and accessed via the Internet (I). A consumer 10 “job seeker” may then continue to navigate the system server 20 website and repeat additional said virtual interviews with different “employers” at will.

A consumer 12 “employer” is able to view a recorded copy of a completed virtual interview composed by consumer 10 “job seeker” whence consumer 12 “employer” receives an email notification from system server 20 indicating that a consumer 10 “job seeker” has completed a virtual interview by answering and completing the virtual interview process as indicated at 55. A consumer 12 “employer's” and consumer's 10 “job seeker's” registration and contact (email) information is collected and stored on system server 20 during the registration process as indicated at 30 and 65. The system server 20 uses this stored information to automatically contact consumers 10 and 12 whence system server 20 learns that a virtual interview has been completed and a specific consumer 12 “employer” should be notified of a completed consumer 10 “job seeker's” virtual interview; Or when a consumer 12 “employer” wishes to ask additional interview questions intended for a specific consumer 10 “job seeker” whence said “employer” would like a follow-up virtual interview or to utilize system server 20's “Virtual Assistant” to re-interview said consumer 10 “job seeker” as indicated at 80.

A consumer 12 “employer” can receive email notification that a consumer 10 “job seeker” has completed their virtual interview questions and can depress a link within said e-mail notification that enables said “employer” to download a copy of said “job seekers” resume via the system server 20 and Internet (I) as indicated at 55. Within said email notification, a consumer 12 “employer” can also depress a link that will automatically log them into the system server 20 via their personal computer and the Internet (I) and enable said “employer” to view a recorded version of the consumer 10 “job seeker” answering said “employers” interview questions via a virtual interview setting whence said “job seeker” is seen interacting with said “Virtual Assistant” generated and stored by system server 20, the inventor's website via the Internet (I) as indicated at 55.

Once a consumer 12 “employer” has completed viewing a virtual interview, said “employer” will have the option to ask additional interview questions intended for a specific consumer 10 “job seeker” whence said “employer” would like a follow-up virtual interview or to utilize system server 20's “Virtual Assistant” to re-interview said consumer 10 “job seeker” by depressing a link within said website web page, entitled “Ask Additional Questions” as indicated at 80.

A consumer 10 “job seeker” can receive a consumer 12 “employers” request for a second interview or re-interview via e-mail notification sent by system server 20 in response to consumer 12 “employers” request as indicated at 85. A consumer 10 “job seeker” depresses a link entitled “Interview Now” within said email notification and is redirected to system server 20's “Virtual Assistant” on the inventor's website web page. Said “job seeker” is prompted to depress a link entitled “Start Interview” whence said “job seeker” is ready to calibrate web cam and answer a series of new interview questions prescribed by a consumer 12 “employer” using the inventor's system server 20, the inventor's web site, the Internet (I), said personal computer and said Internet Service Provider (ISP). Whence a consumer 10 “job seeker” depresses said “Start Interview” link, said virtual interview takes place repeating said process, said storing of recorded interview takes place on system server 20 and said email notifications are sent to said “employer” allowing said “employer” to view the latest version of said virtual re-interview; Hence the process indicated herein is repeated in the same manner until said “employer” is satisfied with said “job seekers” virtual interviews whence said “employer” may contact said “job seeker” outside of said inventor's web server system 20 and begin a formal hiring process.

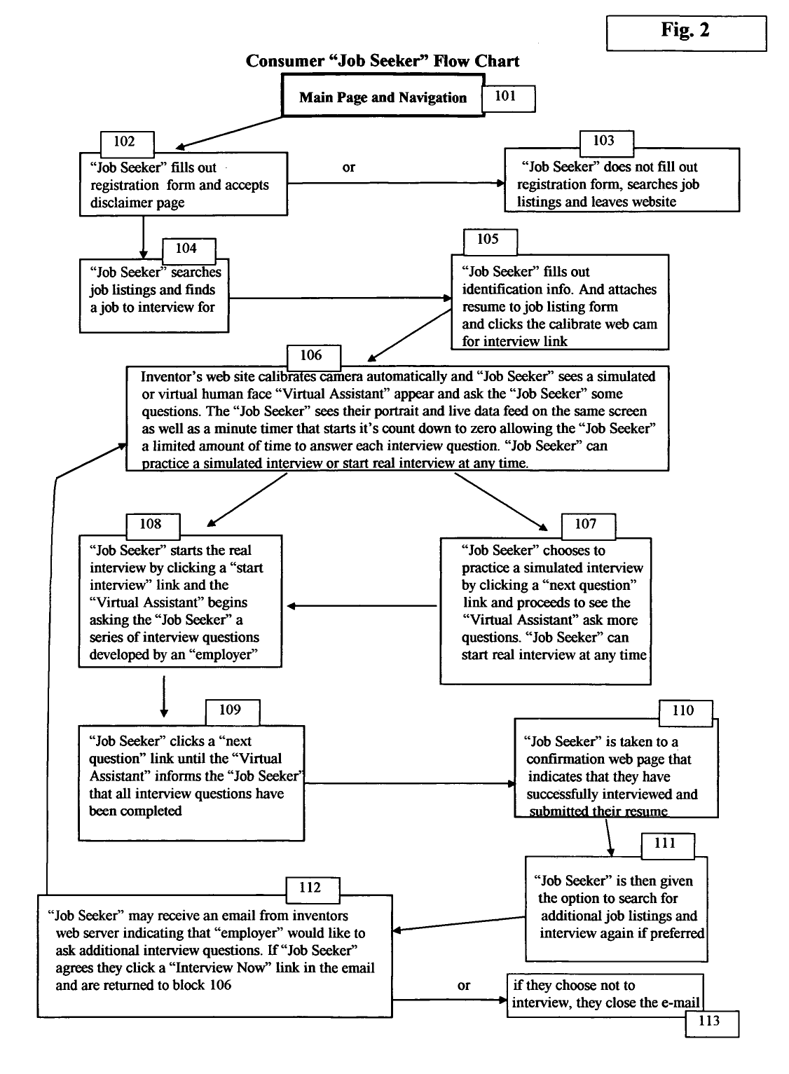

Referring now to (FIG. 2), “Consumer “Job Seeker” Flow Chart” the method of the present invention will now be described in greater detail from the perspective of the consumer “job seeker” utilizing his or her personal computer.

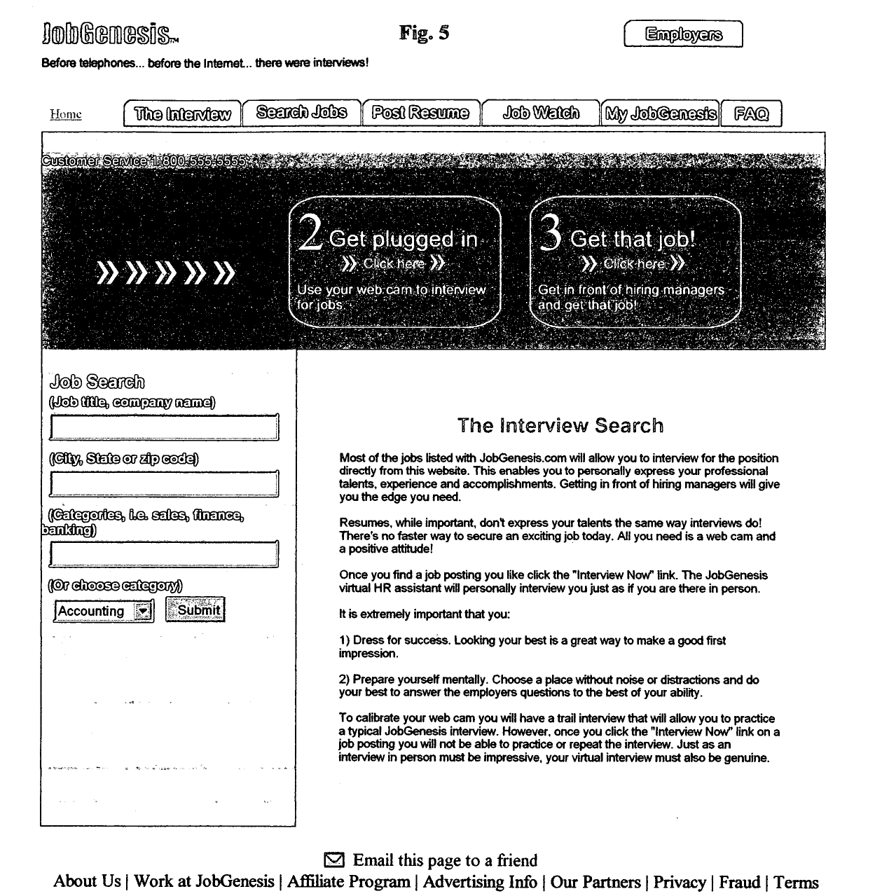

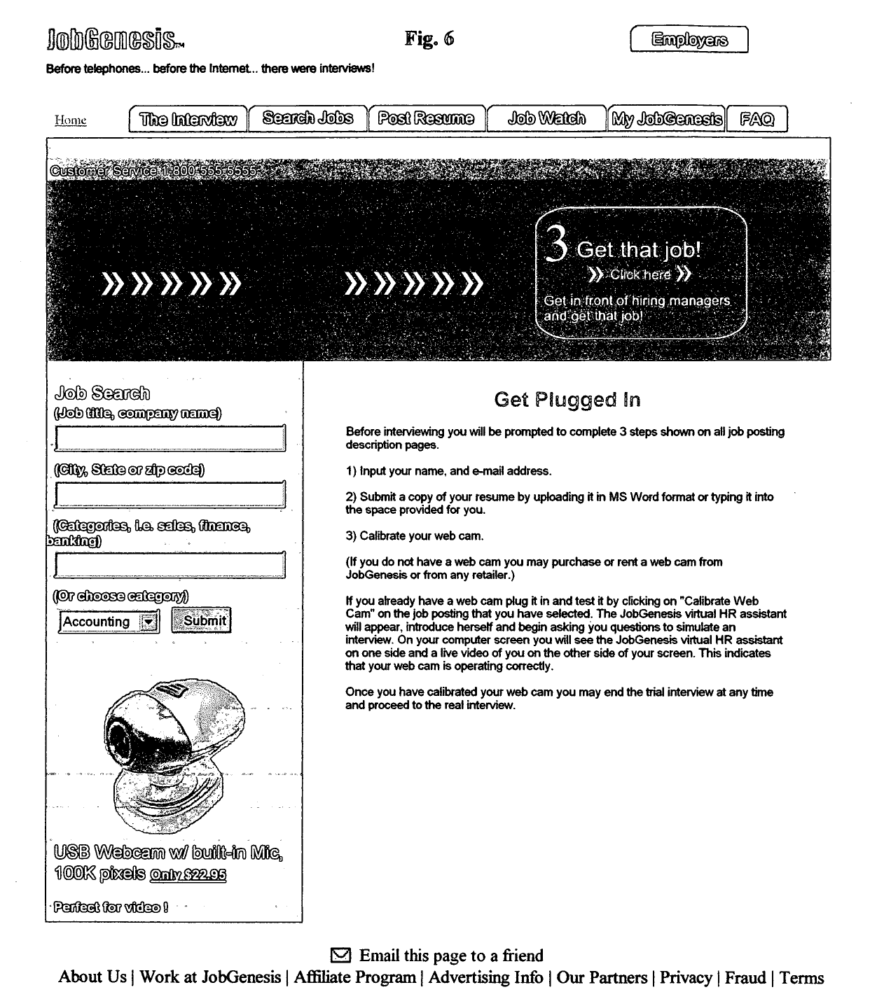

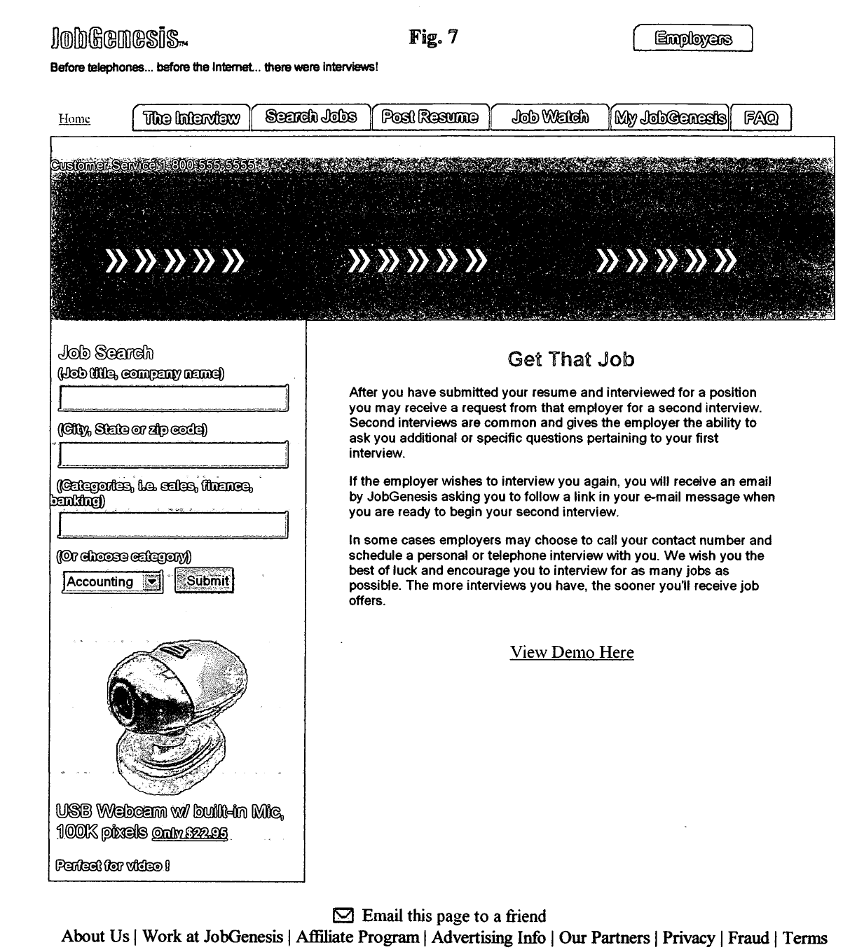

As indicated at box 101, the consumer “job seekers” computer accesses the main page of the system website (FIG. 4) and is able to navigate to (FIGS. 4, 5, 6, & 7) informing the “job seeker” of the purpose of the invention as well as providing the registration information form for participation (FIG. 9)

The consumer searches job listings at box 103 without registering to a specific job listing and leaves the website.

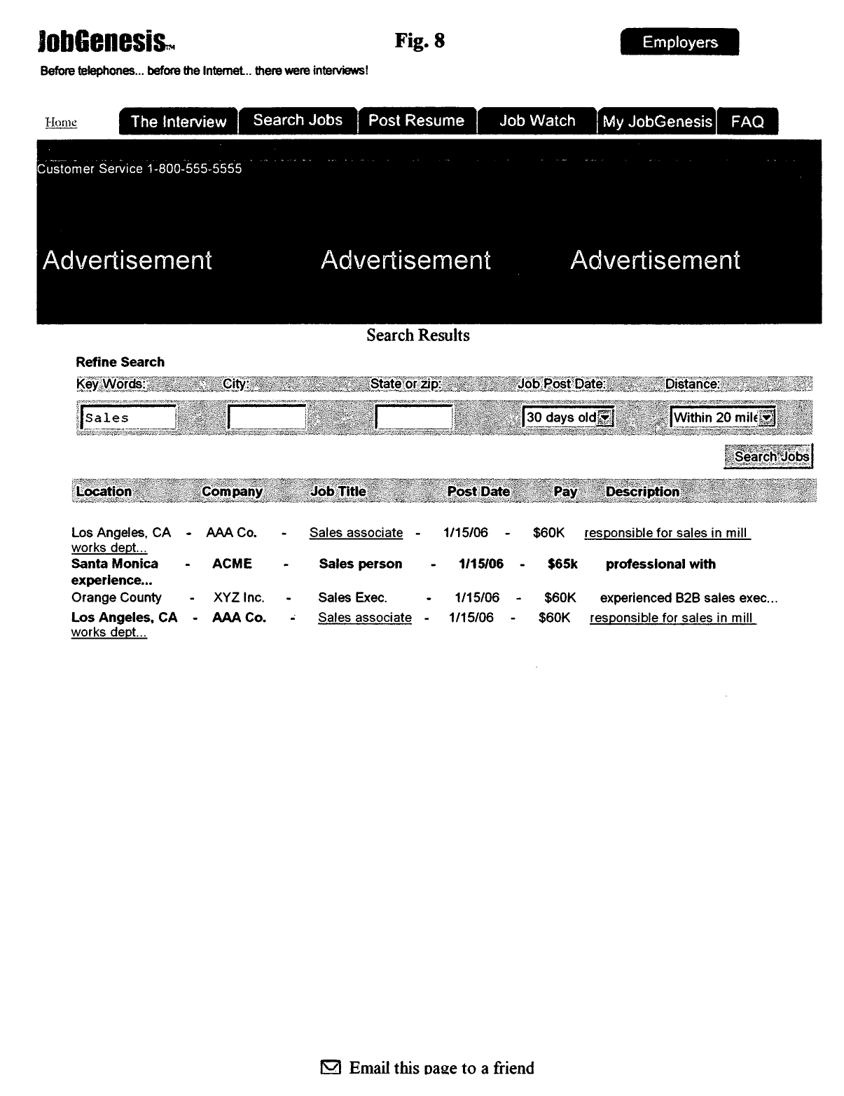

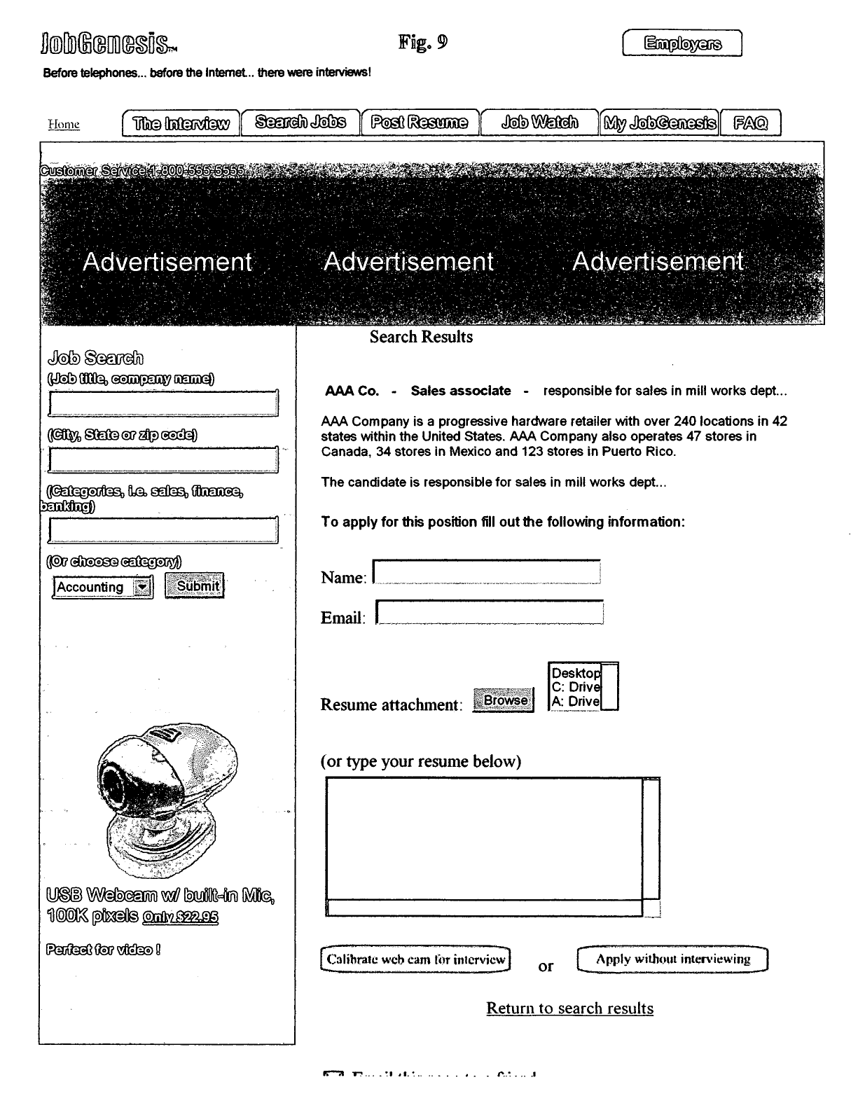

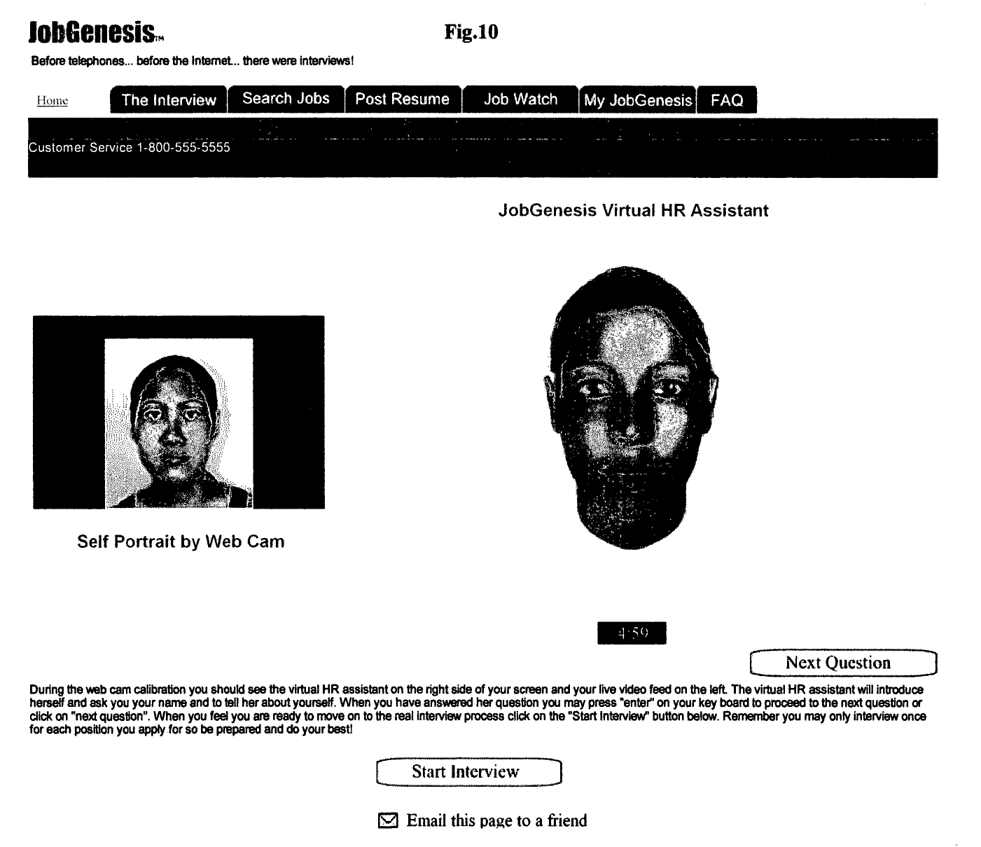

Alternatively, assume the consumer “job seeker” agrees to the terms and conditions and the registration and navigates to a job listing found by a search result (FIG. 8) as indicated at box 104, whereby they continue to (FIG. 9) and must input their identification information, attach a resume and choose to calibrate their web cam for interviewing or apply to the job listing by sending a resume without interviewing as indicated at box 105. Assuming the “job seeker” selects the “calibrate web cam for interview” option wishing to advance to the virtual interview process, they are taken to a web page that displays a simulated virtual human face called “Virtual HR Assistant” also known herein as “Virtual Assistant” (FIG. 10) as indicated at box 106. This web page enables the “job seeker” to view a self-portrait live video feed of them appearing on the left side of said web page produced by system server 20. This indicates that the web cam is functioning properly and the “job seeker” is given the opportunity to interact with the “Virtual Assistant” in a trial procedure for practice (FIG. 10). The “job seeker” is able to hear an audible voice, view animated facial, mouth and eyelid movement by the “Virtual Assistant” when asking the “job seeker” trail or actual interview questions. The “job seekers” personal computer (and its sound speakers) serves as the platform commanded by the inventor's system server 20 through an Internet Service Provider enabling the “job seeker” to hear and see the lifelike initiations and responses of the “Virtual Assistant” (FIG. 10).

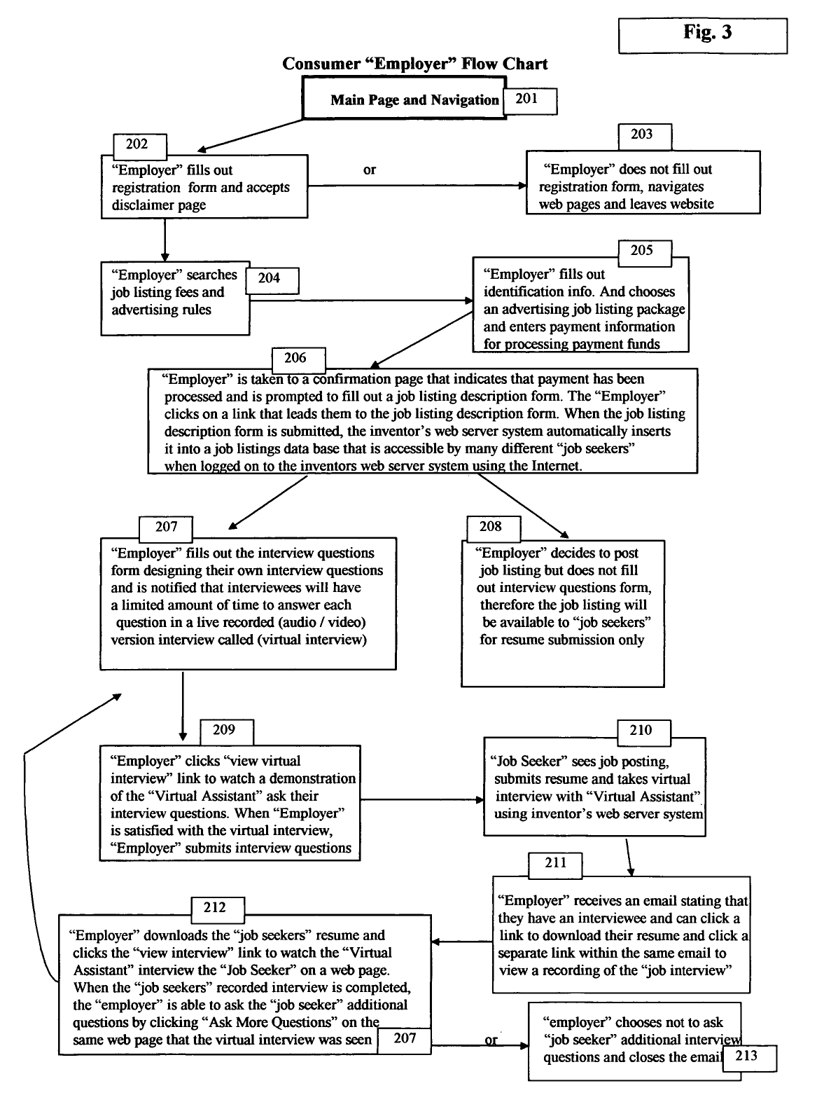

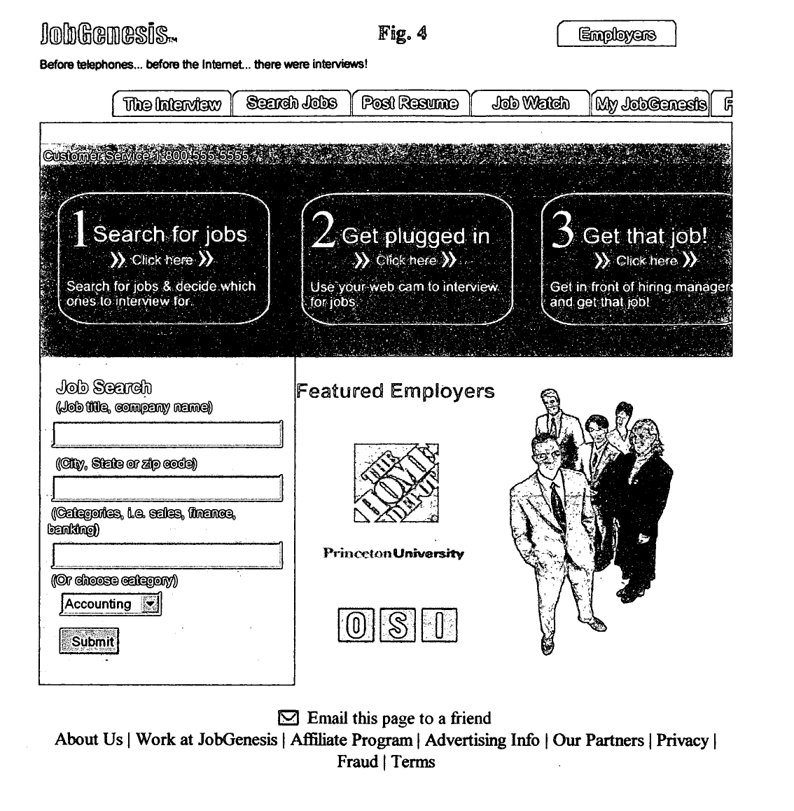

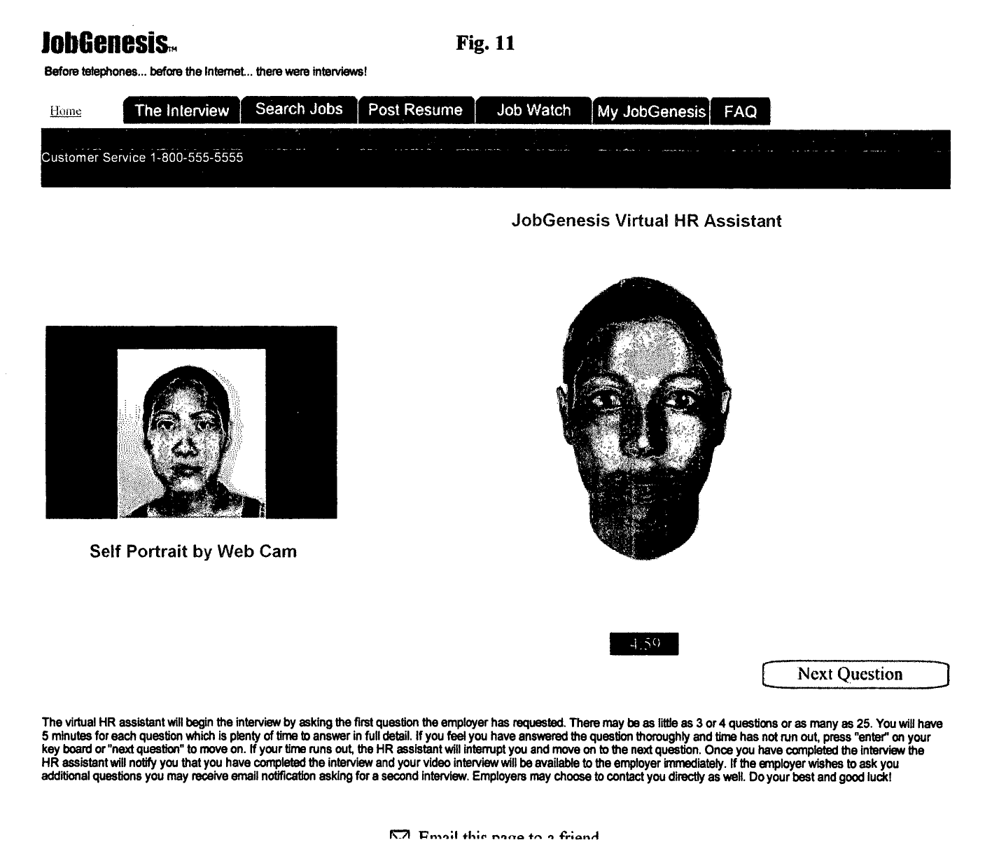

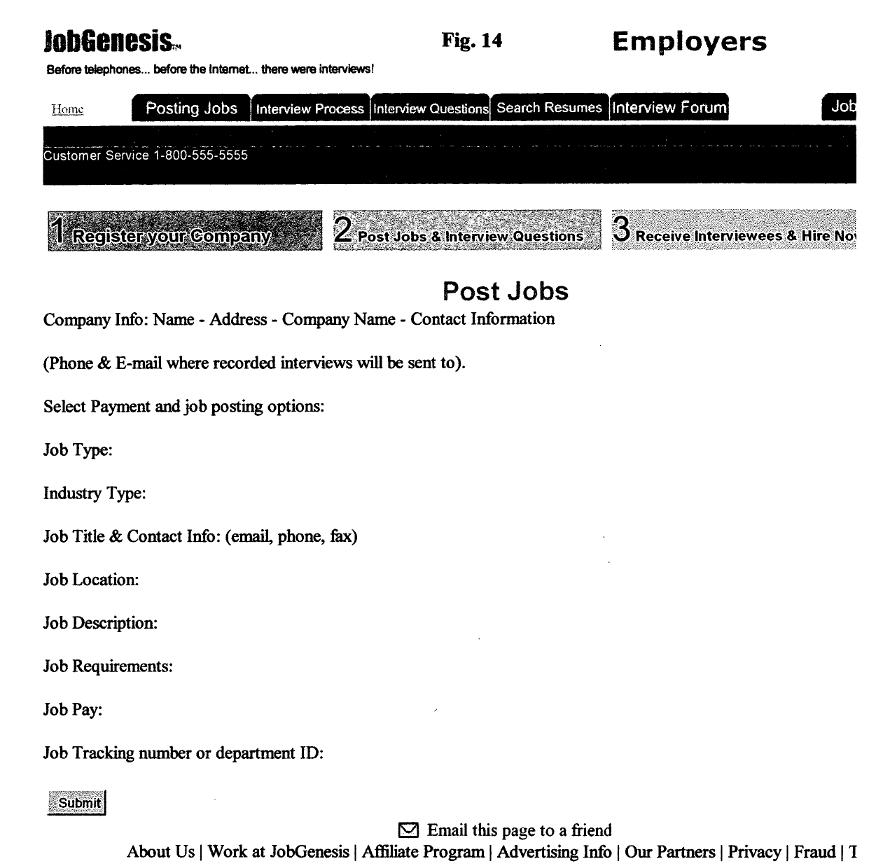

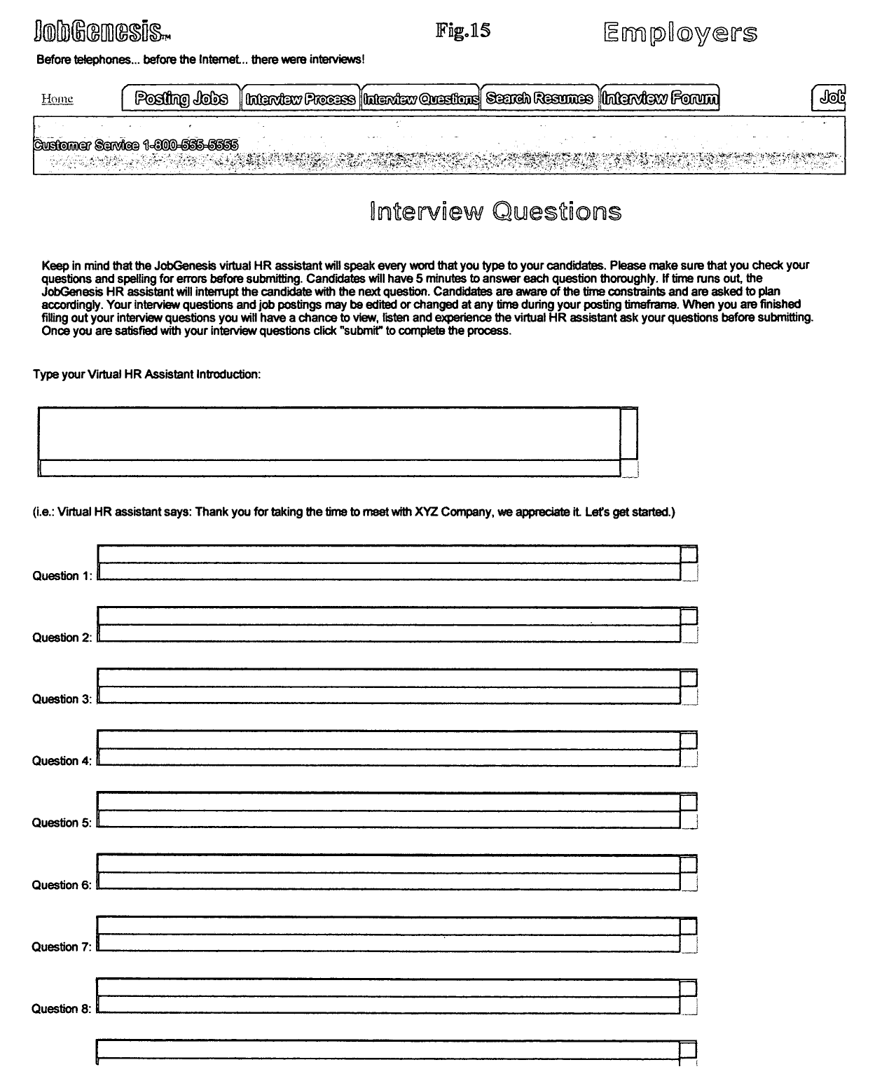

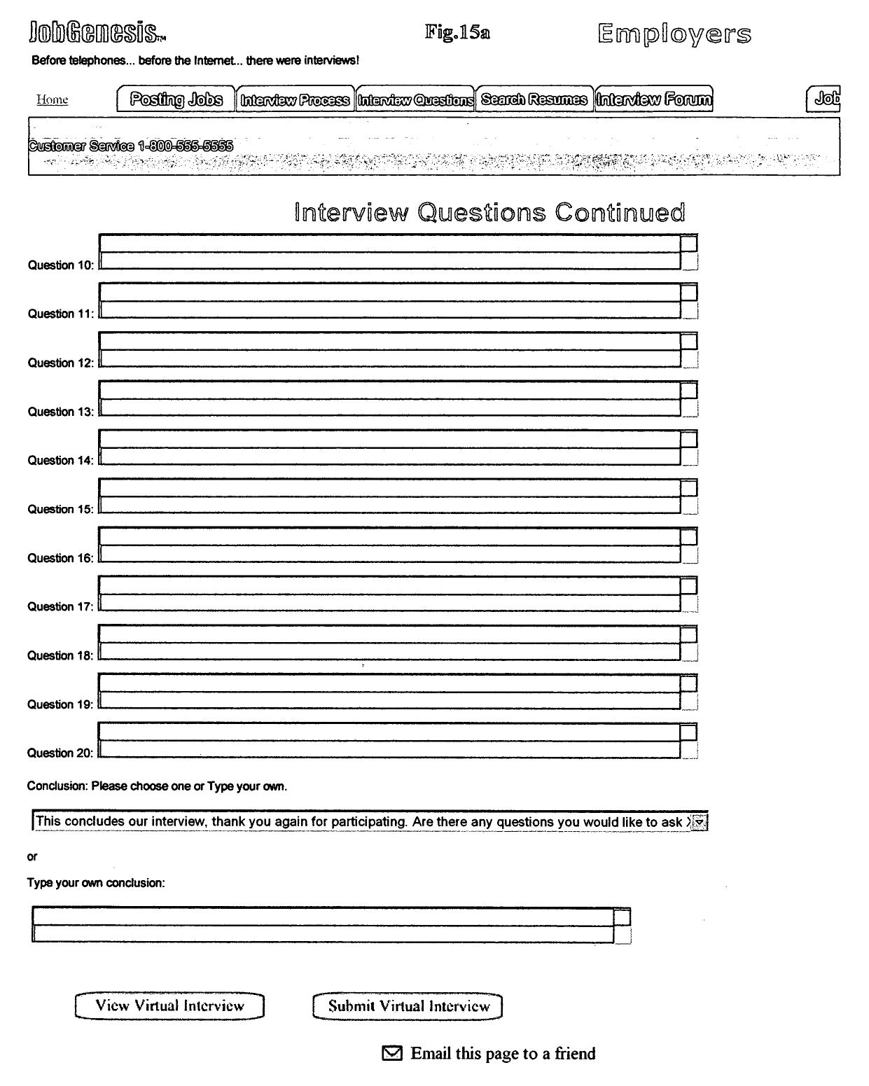

The “job seekers” personal computer with properly installed web cam or “micro cam” (web cam with built-in microphone) enables the inventor's system server 20 to record the “job seekers” interaction with the “Virtual Assistant” which is then stored on said inventor's server system 20. The “job seeker” also sees a small box on said web page containing a timer counting down to zero. The “job seeker” is informed that they will have a certain amount of time to complete each question asked by the “Virtual Assistant” before the “Virtual Assistant” automatically moves on the next question as seen by (FIG. 10) and indicated by box 106. Assuming the “job seeker” feels comfortable interacting with the “Virtual Assistant” they move forward to the real interview by clicking “Start Interview” as seen by (FIG. 10) and indicated at box 108. The “job seeker” is then taken to a new web page showing the “Virtual Assistant” on the right, a “job seeker” self portrait on the left, a timer box beneath the “Virtual Assistant” and a “Next Question” button to the right of the “Virtual Assistant” as seen by (FIG. 11). The “Virtual Assistant” begins asking the “job seeker” interview questions developed by an “employer” that posts job listings and interview questions to the inventor's system server 20 as seen in FIG. 2, at box 108, and FIG. 3, at boxes 205, 206, 207 and (FIGS. 14 and 15).

When the “job seeker” is ready to advance to the next question, the “Next Question” button is clicked or the “job seeker” my depress the “enter” key on their key pad to advance to the next interview question as indicated at box 109. Once the “job seeker” has answered all interview questions prescribed by the “employer” they are automatically taken to a new web page that explains that they have successfully completed the virtual interview and submitted their resume to the “employer” as indicated at box 110. The “job seeker” is then given the opportunity to search for more job listings and repeat said virtual interview process or leave the web site as indicated at box 111. It is possible for said “job seeker” to receive an email sent by the inventor's system server informing the “job seeker” that an “employer” has viewed their virtual interview and would like to ask said “job seeker” additional interview questions as indicated at box 112. If the “job seeker” chooses not to interview again they may simply delete or close the email as indicated at box 113.

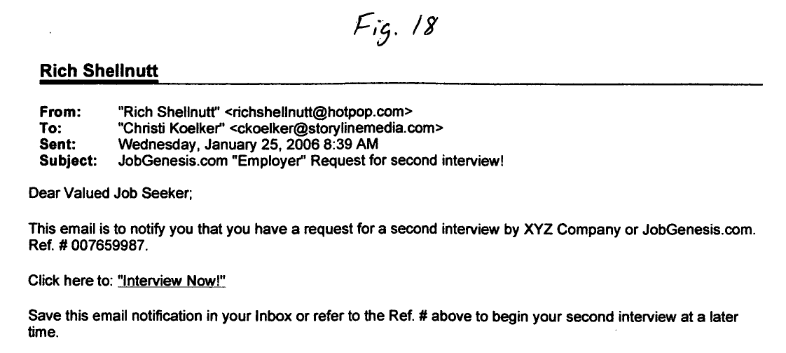

Assuming said “job seeker” decides to re-interview and answer the additional questions the “employer” has requested, the “job seeker” clicks the link within the email notification entitled “Interview Now” as seen in (FIG. 18). The “job seeker” is then redirected back to the inventor's web site via an Internet Service Provider and repeats the steps in FIG. 2 box 106, 107, 108, 109, and 110. This process may continue infinitely until the “employer” ceases prescribing additional interview questions or the “job seeker” ceases answering the “employers” interview questions.

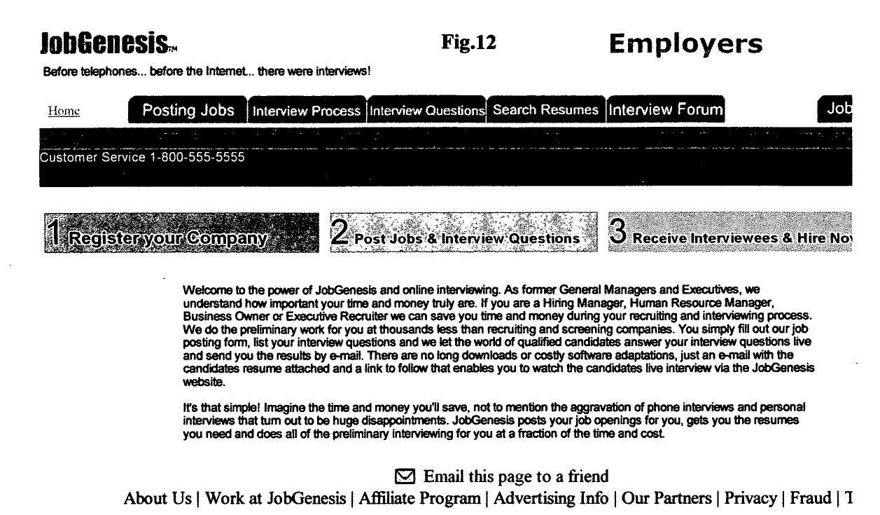

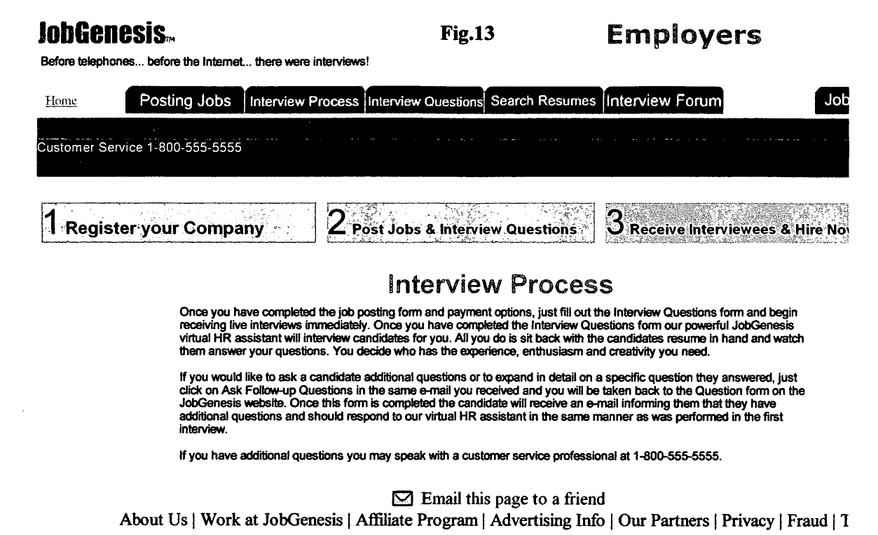

With particular reference to (FIG. 3), “Consumer “Employer” Flow Chart” considering now the inventive method with respect to the use of the system by a consumer “employer.” As indicated at box 201, the consumer “employer's” computer accesses the main page of the system website (FIG. 4) and is able to navigate to (FIGS. 4, 12, & 13) informing the “employer” of the purpose of the invention as well as providing the registration information form for participation (FIG. 14)

The consumer “employer” navigates to the registration form and views job listing fees “fees not shown” at box 203 without registering and leaves the website.

Alternatively, assume the consumer “employer” agrees to the terms and conditions and the registration and navigates to the registration form and starts registration (FIG. 14) as indicated at box 202. The “employer” then navigates to a web page that lists fees for posting job listings on the inventor's web server system 20 as indicated by box 204. The “employer” must then complete the registration form and select a fee option for listing job openings and input payment information as indicated at box 205. Whence the payment, and registration form is processed by system server 20 via the Internet, a confirmation page indicating that registration was successful appears then automatically redirects the “employer” to a job listing description form that must be completed as indicated by box 206 and (FIG. 14). Whence the job listing description form is submitted by the “employer” the inventor's web server system server 20 inserts and stores the listing into a job listings database that is accessible by many different “job seekers” when logged on to the inventor's server system 20 via the inventor's website and Internet as indicated at box 206. The “employer” is then automatically redirected to the interview questions form web page (FIG. 15) and may fill in interview questions enabling “job seekers” to perform virtual interviews. Alternatively the “employer” may decide not to allow virtual interviews and bypass the interview questions form as indicated at box 208.

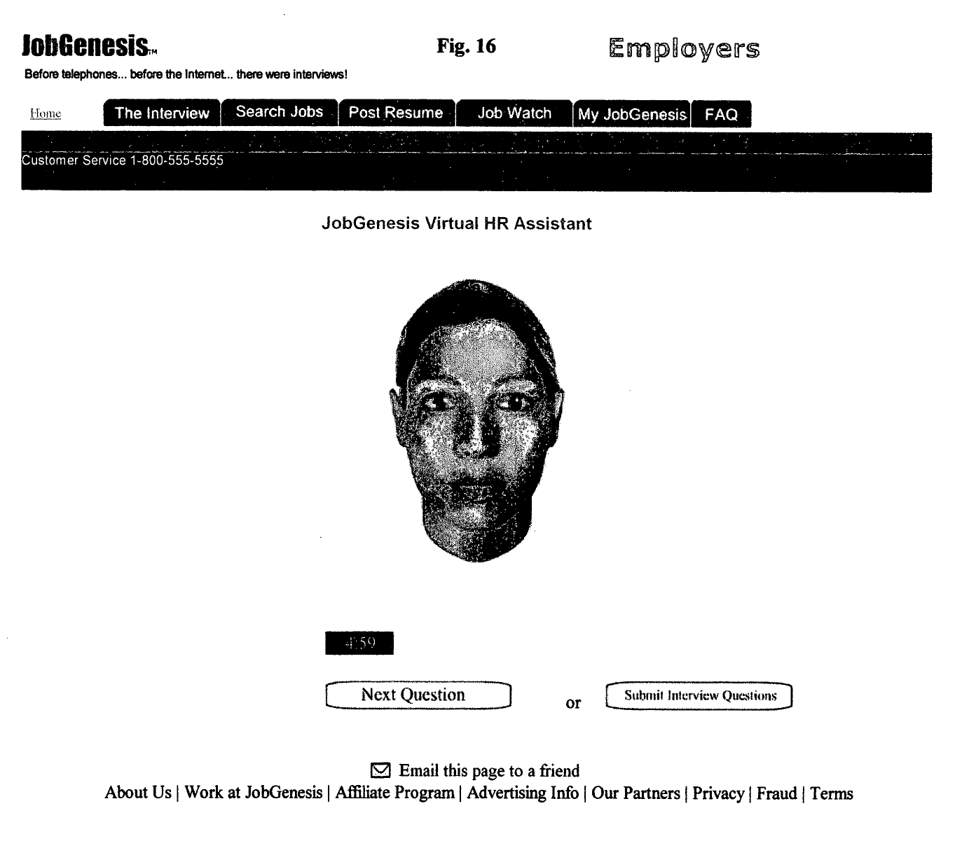

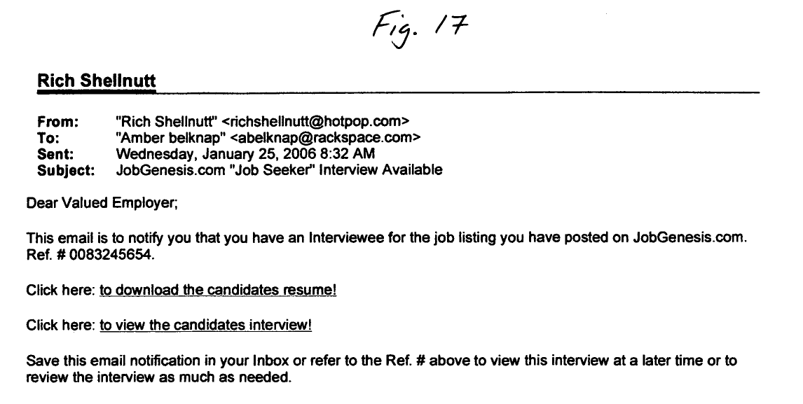

Assuming the “employer” does wish to allow virtual interviews, the “employer” completes the interview questions form by making up and typing in their own questions in the form fields provided (FIGS. 15 & 15a). The “employer” is informed that “job seekers” will have an allotted timeframe to answer each question and is prompted to view the virtual interview for approval or submit the interview questions as indicated at box 207 and seen by (FIG. 15a). The “employer” decides to view the virtual interview before submitting it to the system server 20 as indicated at box 209. The “employer” is then taken to a web page where the “Virtual Assistant” appears (FIG. 16) and begins asking the “employer” the same questions the “employer” prescribed when using the interview questions form (FIGS. 15 & 15a) as indicated at box 209 and stored on system server 20. Once the “employer” is satisfied with the virtual assessment of the prescribed questions, the “Submit Interview Questions” option is selected as seen at (FIG. 16) and the “employers” interview questions are stored on system server 20 until queried (by search engine on inventor's website web pages) by a “job seeker” as indicated at box 210 and indicated at box 104 and seen with (FIGS. 8 and 9). A consumer “job seeker” then queries the job listing using the inventor's web server 20 and Internet website, submits their resume and completes the virtual interview process as explained in FIG. 2 and indicated at box 210.

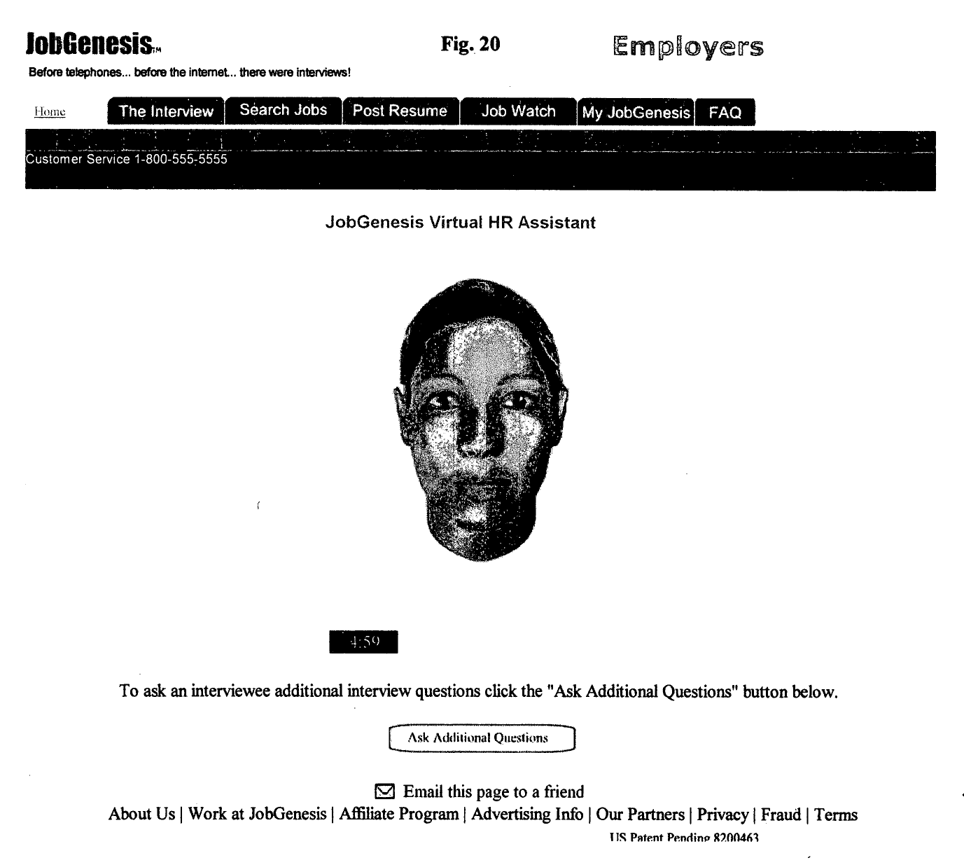

The consumer “employer” is able to receive email notifications form the system server 20 indicating whence a “job seeker” has queried the “employers” job listing, registered, attached a resume and completed the “employers” interview questions as indicated at box 211. The “employer” is able to click on a link within the same email notification that redirects the “employer” back to the inventor's system server 20 website via the Internet and view a “job seekers” recorded virtual interview. The “employer” may ask the “job seeker” additional questions or request a second interview with the “job seeker” by clicking a link within the same web page that the “employer” viewed the virtual interview entitled “Ask Additional Questions” as indicated at box 212 and seen in (FIG. 20). After clicking “Ask Additional Questions” the “employer” is directed back to the interview question form as indicated at box 207 and completes the form (FIGS. 15 and 15a) repeating box 209. The system server 20 stores the new or additional interview questions and notifies the “job seeker” by email that the “employer” is requesting a second interview or additional questions be answered as seen in (FIG. 18). The “job seeker” chooses to proceed with the second interview and clicks the “Interview Now” link within the email and is redirected back to the inventor's web server system website where the “job seeker” sees the “Virtual Assistant” waiting to carry out a second virtual interview with the “job seeker” as seen indicated at box 112 and seen in (FIG. 10). The “job seeker” repeats the virtual interview process starting at box 106 and repeating steps 107, 108, 109, 110 and 111.

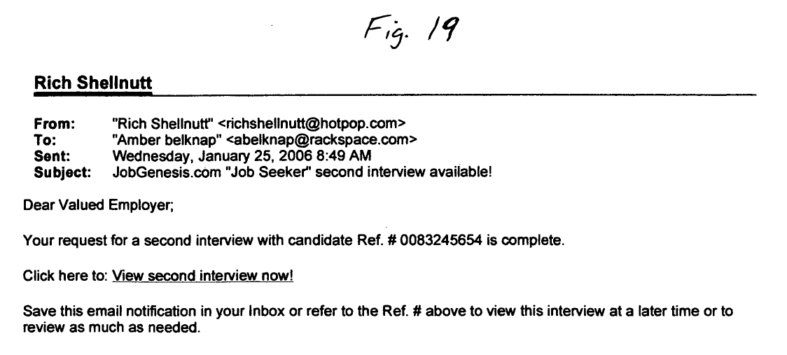

Whence the “job seeker” completes said second virtual interview process, the “employer” receives a second email notification prompting the viewing of the second virtual interview by clicking a link within said email notification entitled “View Second Interview Now” as seen in (FIG. 19). The “employer” is redirected back to the inventor's web server system 20 via the Internet and is able to view the recording of the “job seekers” second virtual interview following the same steps as indicated at box 212 and seen in FIG. 20. Said process can be repeated indefinitely or until “employer” or “job seeker” ceases to respond to email notifications or “employer's” job listing expires or is terminated by the “employers” request or the inventor's discretion.

What is claimed is:

1. A method of facilitating consumer transactions, comprising:
utilizing a system server;
receiving at the system server a consumer “employer” transaction listing a job opportunity with scripted interview questions whereas a system server converts information into a virtual interview format;
communicating a system transaction job listing and converted virtual interview opportunity to unlimited “job seekers” in response to the receipt of said “employer” listing;
receiving many resumes and recordings of completed virtual interviews indicative to a response to the job listing of said “employer” from many consumers “job seekers” computers and web cams;
sending to said consumer “employer” a notification “email” that said “job seekers” have completed and or participated in said virtual interview; and
sending to said consumer “employer” notification or “email” with access link for viewing recorded virtual applicant interviews in an attempt to complete an employment transaction; and
sending to said “job seeker” notification or “email” that said “employer” wishes to view said “job seeker” answering additional interview questions in said virtual interview format.

2. A method according to claim 1, wherein said receiving said transaction listing occurs using a global communications network.

3. A method according to claim 1, wherein said communicating a system transaction job listing occurs using a global communications network.

4. A method according to claim 1, wherein said receiving many resumes and recordings occurs using a global communications network.

5. A method according to claim 1, wherein said receiving a notification email of completed virtual interview occurs using a global communications network.

6. A method according to claim 1, wherein said receiving a notification email with access link occurs using a global communications network.

7. A method according to claim 1, wherein said receiving a notification email to answer additional interview questions occurs using a global communications network.

8. An apparatus for facilitating consumer transactions, comprising:
means for utilizing a system server;
means for receiving at the system server a consumer “employer” transaction listing a job opportunity with scripted interview questions whereas a system server converts information into a virtual interview format;
means for communicating a system transaction job listing and converted virtual interview opportunity to unlimited “job seekers” in response to the receipt of said “employer” listing;
means for receiving many resumes and recordings of a completed virtual interviews indicative to a response to the job listing of said “employer” from many consumers “job seekers” computers and web cams;
means for sending to said consumer “employer” a notification “email” that said “job seekers” have completed and or participated in said virtual interview;
means for sending to said consumer “employer” notification or “email” with access link for viewing recorded virtual applicant interviews in an attempt to complete an employment transaction;
means for sending to said “job seeker” notification or “email” that said “employer” wishes to view said “job seeker” answer additional interview questions in said virtual interview format.

9. An apparatus according to claim 8, wherein said receiving said transaction listing occurs using a global communications network.

10. A method according to claim 8, wherein said communicating a system transaction job listing occurs using a global communications network.

11. A method according to claim 8, wherein said receiving many resumes and recordings occurs using a global communications network.

12. A method according to claim 8, wherein said receiving a notification email of completed virtual interview occurs using a global communications network.

13. A method according to claim 8, wherein said receiving a notification email with access link occurs using a global communications network.

14. A method according to claim 8, wherein said receiving a notification email to answer additional interview questions occurs using a global communications network.
